(19) United States
(12) Patent Application Publication
(10) Pub. No.: US 2012/0114279 A1
(43) Pub. Date: May 10, 2012

(54) ROLLER FOR A ROLLING BEARING

(75) Inventor: Olivier Blanchin, Annecy (FR)

(73) Assignee: NTN-SNR ROULEMENTS, Annecy (FR)

(21) Appl. No.: 13/253,287

(22) Filed: Oct. 5, 2011

(30) Foreign Application Priority Data
Oct. 12, 2010 (FR) 10/04024

(51) Int. Cl. F16C 33/36; F16C 33/46; F16C 19/22

(52) U.S. Cl. 384/568; 384/565; 384/569

(57) ABSTRACT

A roller for a rolling bearing has an outer surface revolving about an axis of symmetry and a lateral face arranged on either side of the outer surface. The roller is intended to rotate in the bearing about the axis of symmetry while bearing on the outer surface. The roller has two recesses produced respectively on one lateral face extending along the axis of symmetry. The recesses have an opening formed on the lateral face and are separated axially by a material bridge. The recesses are defined by a lateral revolving surface, the shape whereof is divergent tapered from the opening to the material bridge.

### BACKGROUND

The invention relates to a roller for a rolling bearing and a rolling bearing wherein such rollers are fitted.

The invention particularly applies to rollers for a planetary gear bearing, particularly a planetary step-down gear satellite bearing for a helicopter gear box.

In this application, the use of solid rollers, particularly having a spherical barrel shape, is known. Each roller has an outer surface revolving about an axis of symmetry and a lateral face arranged on either side of said outer surface. These rollers are intended to be fitted in the bearing, by being arranged in a retention cage so as to be able to rotate in said bearing about the axis of symmetry thereof while bearing on the outer surface thereof.

For this purpose, the lateral faces of the rollers may have a recess wherein an axial projection of the cage is inserted so as to keep each of said rollers rotating about the axis of symmetry thereof. The embodiment of a roller according to the preamble of claim 1 is also known, particularly from DE-10 2006 052 044.

However, the satellite bearings according to the prior art have a significant weight, which is particularly critical for an aeronautical application wherein five to ten bearings are conventionally placed in a planetary step-down gear fitted in a gear box.

Moreover, particularly in this application, rollers are subject to very significant charge/discharge cycles inducing structural fatigue.

### SUMMARY OF THE INVENTION

The aim of the invention is that of enhancing the prior art by particularly providing rollers for rolling bearings which have a lower weight while meeting the functional requirements of the bearing, particularly in relation to the structural fatigue of said rollers under the effect of charge/discharge cycles to which they are subjected over time.

For this purpose, according to a first aspect, the invention relates to a roller for a rolling bearing, said roller having an outer surface revolving about an axis of symmetry and a lateral face arranged on either side of said outer surface, said roller being intended to rotate in said bearing about the axis of symmetry thereof while bearing on the outer surface thereof, said roller having two recesses produced respectively on one lateral face extending along the axis of symmetry, said recesses having an opening formed on the lateral face and being separated axially by a material bridge, the recesses each being defined by a lateral revolving surface, the shape whereof is divergent tapered from said opening to said material bridge.

According to a second aspect, the invention relates to a rolling bearing comprising an inner member and outer member between which such rollers are fitted, said rollers being arranged in a retention cage so as to be able to rotate about the axis of symmetry thereof while bearing on said members via the outer surface thereof.

### BRIEF DESCRIPTION OF THE DRAWINGS

Further aims and advantages of the invention will emerge in the description hereinafter, with reference to the attached figures wherein:

FIG. 1 shows a cut perspective view of a rolling bearing according to one embodiment of the invention;

FIG. 2 shows a longitudinal section view of a roller according to one embodiment of the invention;

FIGS. 3a and 3b show a longitudinal section view of a roller respectively according to one alternative embodiment of the embodiment in FIG. 2;

FIG. 4 shows a longitudinal section view according to an embodiment of the invention.

### DETAILED DESCRIPTION OF THE PREFERRED EMBODIMENT(S)

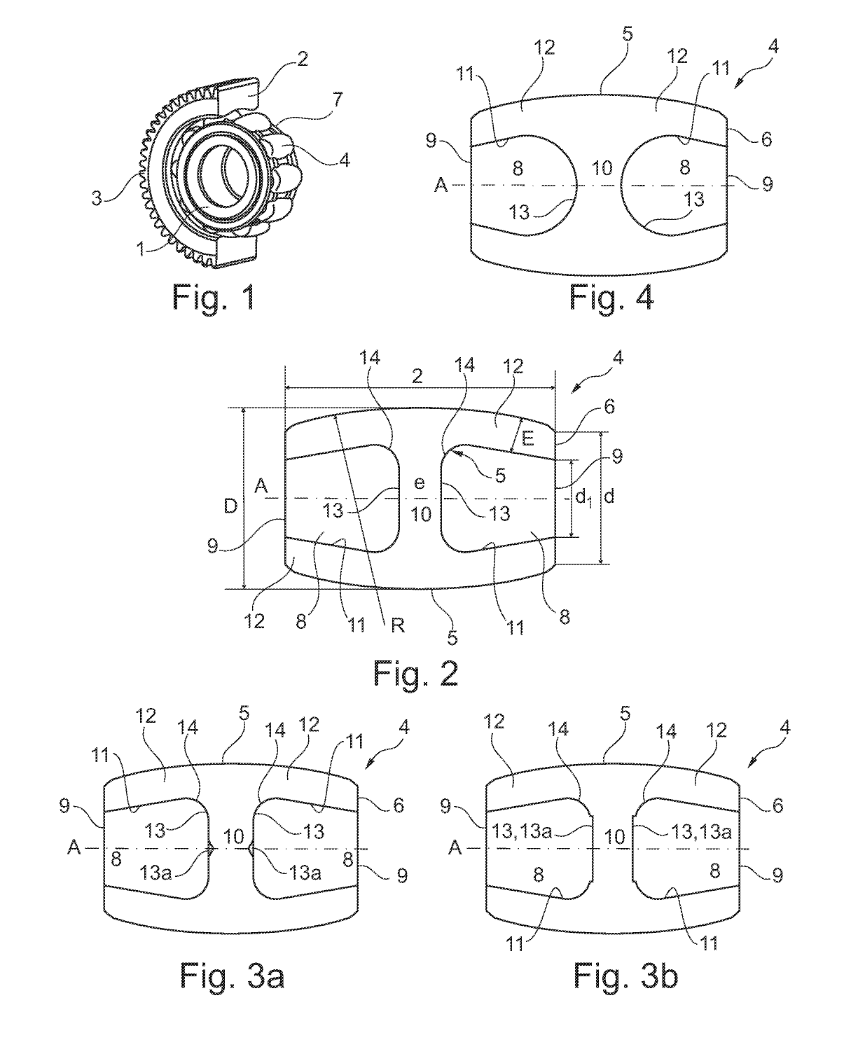

With reference to FIG. 1, an embodiment of a rolling bearing in the form of a planetary step-down gear satellite bearing for a helicopter gear box is described below. The planetary gear is an effective mechanical principle for transmitting power and reducing speed in a compact space. However, since this mechanical assembly requires a plurality of bearings, typically between five and ten, it has a significant weight.

The bearing comprises an inner ring 1 and an outer ring 2. For this application, the outer surface of the outer ring 2 is provided with gear means formed from axial toothing 3. In one alternative embodiment not shown, a rolling bearing according to the invention may find an application in another field particularly wherein weight gain of said bearing is desirable.

The rings 1, 2 each comprise a bearing track between which a row of rollers 4 is arranged so as to enable the relative rotation of said rings.

One embodiment of the rollers 4 is described below, each having an outer surface 5 revolving about an axis of symmetry A and a lateral face 6 arranged on either side of said outer surface. In view of the power to be transmitted and the high gear ratio, the rollers 4 may be made of metallic material particularly 100Cr6 type bearing steel. In one alternative embodiment, the rollers 4 may be made of ceramic material.

In the bearing, the rollers 4 are intended to rotate about the axis of symmetry A thereof, said rollers bearing on the bearing tracks via the outer surface 5 thereof. Moreover, during rotation, the lateral faces 6 are guided along a shoulder or the retention cage 7 so as to hold the rollers 4 in the bearing.

In the embodiment shown, the outer surface 5 has a spherical barrel shape having a radius R (commonly referred to as a barrel roller) wherein the diameter d of the lateral faces 6 is less than the maximum diameter D of said outer surface. In the embodiment shown, the barrel shape is symmetric with the maximum diameter D formed at the centre of the outer surface 5. In an alternative embodiment, the barrel shape may be dissymmetric with the maximum diameter D offset on one side or the other with respect to the centre of the outer surface 5.

The lateral faces 6 extend respectively in a transverse plane with respect to the axis of symmetry A, the diameters d being measured in the transverse planes and said planes being spaced by a length L corresponding to that of the roller 4. In an alternative embodiment not shown, the roller 4 may have a cylindrical or conical shape.

In order to gain weight in the bearing, the invention proposes to lighten the rollers 4 fitted therein. For this purpose, the rollers 4 have two recesses 8 produced, particularly by drilling, turning or milling, respectively on one lateral face 6 extending along the axis of symmetry A. The recesses 8 have an opening 9 formed on the lateral face 6 and are separated axially by a material bridge 10.

However, the rollers 4 are subjected to structural fatigue under the effect of charge/discharge cycles applied over time. In order to meet the functional requirements of the bearing, particularly in relation to said fatigue, while reducing the weight, the invention proposes to reduce the quantity of material of the rollers 4 in the zones subject to the least mechanical stress and to retain the quantity elsewhere.

For this purpose, the recesses 8 are each defined by a lateral revolving surface 11, the shape of which is divergent tapered from the opening 9 to the material bridge 10. In this way, the undercut shape of the recesses 8 enables a significant weight gain, namely in the region of 25% with respect to a solid roller, and the material bridge 10 makes it possible to retain the rigidity required for fatigue resistance. In particular, a maximum amount of material is retained in the zone with the larger diameter D of the roller 4 which is subject to the greatest stress due to the contact between the outer surface 5 and the bearing tracks.

Indeed, the maximum diameter D of the outer surface 5 is arranged about the material bridge 10, at the centre of said surface in the embodiment shown. In this way, the contact (or Hertzian) zone between a roller 4 and the bearing tracks is positioned next to the centre of the roller 4, i.e. next to the material bridge 10, the depth of the Hertzian stress being directly linked with the level of contact pressure between the roller 4 and the bearing tracks.

Moreover, the revolving shape of the recesses 8 makes it possible not to modify the balance of the roller 4 and the outer shapes are not affected compared to those of a solid roller, such that no major changes in bearing production and assembly are required.

Each recess 8 is surrounded by a revolving wall 12 defined radially between the lateral surface 11 and the part of the outer surface 5 arranged radially opposite. The undercut embodiment of the recesses 8 particularly makes it possible to arrange the lateral surface 11 such that the thickness E of the wall 12 is substantially constant. In particular, for barrel rollers 4, the angle of divergence of the lateral surface 11 may be substantially equal to that of the outer surface 5 so as to obtain a constant wall 12 thickness E.

In one example of an embodiment enabling a satisfactory compromise between weight and fatigue resistance, the thickness E of the wall 12 may be between 10% and 40% of the maximum diameter D of the outer surface 5.

According to a further advantageous feature in relation to this compromise shown in FIGS. 2 and 3, each recess 8 may have a base 13 extending radially on the material bridge 10, the lateral surface 11 being connected to said base by a fillet 14 forming a radius r. In particular, the radius r of the fillet 14 may be greater than 1.5 mm. In this way, on the zone subject to the greatest stress on the rollers 4, any risk of local overstressing due to sharp angles or uncontrolled surface connections is removed. In the embodiment shown in FIG. 4, each recess 8 has a base 13 forming a connection radius with the lateral surface 11.

Moreover, as shown in FIGS. 3, the radial base 13 may have an inside recess 13a, respectively having a conical shape (FIG. 3a) in the vicinity of the centre of said base or having an elongated shape on substantially the entire height of said bottom (FIG. 3b).

According to a further advantageous feature of the invention, the opening 9 has a diameter d₁ measured on the lateral face 6 and the material bridge 10 has a length e, said diameter and said length meeting the following geometric condition:

$$0.1 \leq \frac{e}{{d}_{1}} \leq 1.$$

In this way, the recesses 8 are arranged to retain a sufficient wall thickness 12 to resist mechanically to the stress applied during bearing rotation.

In particular, the length e of the material bridge 10 is determined according to the application so as to be sufficient to ensure, with the applicable safety margins in said application, that there is no risk of rupture due to the fatigue of a roller 4 in the bearing.

Moreover, to ensure the guidance reliability on the lateral faces 6, the diameter d₁ may be such that d−d₁≧1 mm , so as to maintain a sufficient guide height of the roller 4 in the bearing.

To enable the retention of the rollers 4 in the bearing space during bearing rotation, said rollers are arranged in a retention cage 7 so as to be able to rotate about the axis of symmetry A thereof while bearing on the members 1, 2 via the outer surface 5 thereof.

According to one embodiment, the cage 7 is formed from a single piece, particularly by machining a metallic material, to comprise a first collar and, offset axially, a second collar, said collars having the same diameter. The cage 7 further comprises a plurality of axial cross members extending between said collars so as to form between two adjacent cross members and the collars a housing for holding a roller 4. In particular, the internal geometry of the housing is formed to mould the periphery of the roller 4 by enabling the rotation thereof about the axis of symmetry A thereof.

Moreover, each lateral face 6 of a roller 4 is arranged opposite respectively a lateral face of a housing, a means for coupling said roller being formed on each lateral face of said housing. According to one embodiment, the coupling means comprises an axial projection inserted into a recess 8 of the roller 4 so as to keep said roller rotating in said housing.

A numerical example for the characteristic geometric dimensions of a roller 4 according to the invention is given below:
L=30 mm
D=20 mm
R=50 mm
d=16 mm
d₁=10 mm
r=2 mm
e=6 mm
E=5 mm

On this roller 4, the weight reduction according to the invention makes it possible to gain approximately 20 g of 70 g which is considerable and very beneficial for the application in question.

1-12. (canceled)

13. Roller for a rolling bearing, said roller having an outer surface revolving about an axis of symmetry and a lateral face arranged on either side of said outer surface, said roller rotating in said bearing about the axis of symmetry while bearing on the outer surface, two recesses produced on one lateral face extending along the axis of symmetry, said recesses having an opening formed on the lateral face and being separated axially by a material bridge, and the recesses each being defined by a lateral revolving surface, having a shape which is divergent tapered from said opening to said material bridge.

14. Roller for a roller bearing according to claim 13, wherein each said recess is surrounded by a revolving wall defined radially between the lateral revolving surface and a part of the outer surface arranged radially opposite said lateral revolving surface so that a thickness of said revolving wall is substantially constant.

15. Roller for a rolling bearing according to claim 14, wherein the thickness of the revolving wall is between 10% and 40% of a maximum diameter of the outer surface.

16. Roller for a rolling bearing according to claim 13, wherein each said recess has a base extending radially on the material bridge, and the lateral surface is connected to said base by a fillet forming a radius.

17. Roller for a rolling bearing according to claim 16, wherein the radius of the fillet is greater than 1.5 mm.

18. Roller for a rolling bearing according to claim 13, wherein each said recess has a base forming a connection radius with the lateral surface.

19. Roller for a rolling bearing according to claim 13, wherein the opening has a diameter (d₁) measured on the lateral face and the material bridge has a length, and said diameter and said length meet the following geometric condition:
$$0.1 \leq \frac{e}{{d}_{1}} \leq 1.$$

20. Roller for a rolling bearing according to claim 13, wherein the lateral faces have a diameter (d) measured in a transverse plane, and the opening having a diameter (d₁) which is such that: d−d₁≧1 mm.

21. Roller for a rolling bearing according to claim 13, wherein the outer surface has a spherical barrel shape and wherein the diameter (d) of the lateral faces is less than the maximum diameter (D) of said outer surface, said maximum diameter being formed about the material bridge.

22. Rolling bearing comprising an inner member and an outer member between which rollers are fitted, each said roller comprising a roller according to claim 13, and said rollers being arranged in a retention cage so as to be able to rotate about the axis of symmetry thereof while bearing on said members via the outer surface thereof.

23. Rolling bearing according to claim 22, wherein the retention cage comprises two collars and a plurality of axial cross members extending between said collars so as to form between two adjacent cross members and the collars a housing for holding one of said rollers, each lateral face of said one roller being arranged opposite respectively a lateral face of said housing, means for coupling said one roller being formed on each lateral face of said housing, and said coupling means comprising an axial projection inserted into a recess of said one roller so as to keep said one roller rotating in said housing.

24. Rolling bearing according to claim 23, wherein the outer surface of the outer member is provided with gear means for use in a planetary gear.
